(19) United States
(12) Patent Application Publication
(10) Pub. No.: US 2013/0272712 A1
(43) Pub. Date: Oct. 17, 2013

(54) INFRARED REMOTELY CONTROLLED CIRCUIT

(71) Applicants: HAI-DONG TANG, Shenzhen City (CN); KUO-PIN LIN, Tu-Cheng (TW)

(72) Inventors: HAI-DONG TANG, Shenzhen City (CN); KUO-PIN LIN, Tu-Cheng (TW)

(73) Assignees: HON HAI PRECISION INDUSTRY CO., LTD., Tu-Cheng (TW); HONG FU JIN PRECISION INDUSTRY (ShenZhen) CO. LTD., Shenzhen City (CN)

(21) Appl. No.: 13/586,805

(22) Filed: Aug. 15, 2012

(30) Foreign Application Priority Data
Apr. 11, 2012 (CN) 201210104275.0

(51) Int. Cl. H04B 10/02

(52) U.S. Cl. 398/106

(57) ABSTRACT

An infrared remotely controlled circuit employed in an electronic device which includes a display panel and a host machine. The infrared remotely controlled circuitry includes a first remotely controlled circuit, a second remotely controlled circuit, and a microprogrammed control unit (MCU). The first remotely controlled circuit includes a first infrared receiver for mounting in the display panel and a first diode with the cathode connected to a first port of the first infrared receiver. The second remotely controlled circuit includes a second infrared receiver for mounting in the host machine and a second diode with the cathode connected to a first port of the second infrared receiver. The MCU is connected to the anode of the first diode to form a first signal input port and the anode of the second diode to form a second signal input port.

### BACKGROUND

1. Technical Field

The present disclosure relates to infrared remotely controlled circuits, and particular to an infrared remotely controlled circuit avoiding crosstalk.

2. Description of the Related Art

The infrared receivers which are employed in an electronic device are vulnerable to crosstalk from infrared remotely controlled signals and resulting misconduct of the electronic device. Referring to FIG. 1, an infrared remotely controlled circuit 10 of related art includes a first remotely controlled circuit 11, a second remotely controlled circuit 12, and a microprogrammed control unit (MCU) 13. The first remotely controlled circuit 11 includes a first infrared receiver 110 mounted on a display panel (not shown) of the electronic device, and a second remotely controlled circuit 12 includes a second infrared receiver 120 mounted on a host machine (not shown) of the electronic device. The first infrared receiver 110 is connected to the MCU 13 to form a first signal input port 130, and the second infrared receiver 120 is connected to the MCU 13 to form a second signal input port 131. The first signal input port 130 and the second signal input port 131 are predetermined to be held at low level before the first infrared receiver 110 and the second infrared receiver 120 receive any infrared remotely controlled signals from a remote controller (not shown). When the first infrared receiver 110 and the second infrared receiver 120 receive any infrared remotely controlled signals, the resulting signal output by the first infrared receiver 110 may be output to the second signal input port 131 and the resulting signal output by the second infrared receiver 120 may be output to the first signal input port 130, because the distance between the first infrared receiver 110 and the remote controller is different from the distance between the second infrared receiver 120 and the remote controller.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a circuit diagram of an infrared remotely controlled circuit of related art.

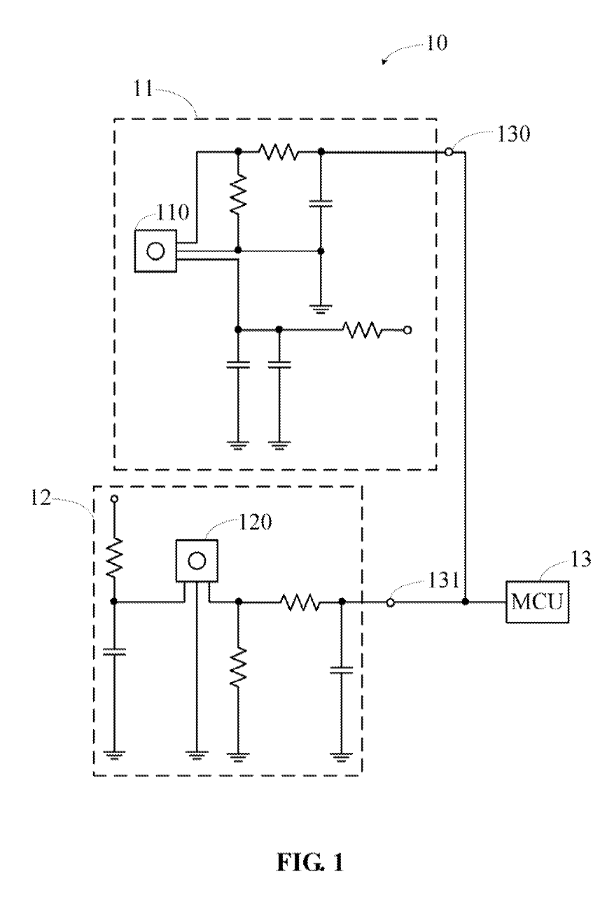

FIG. 2 is a circuit diagram of an infrared remotely controlled circuit in accordance with an exemplary embodiment.

### DETAILED DESCRIPTION

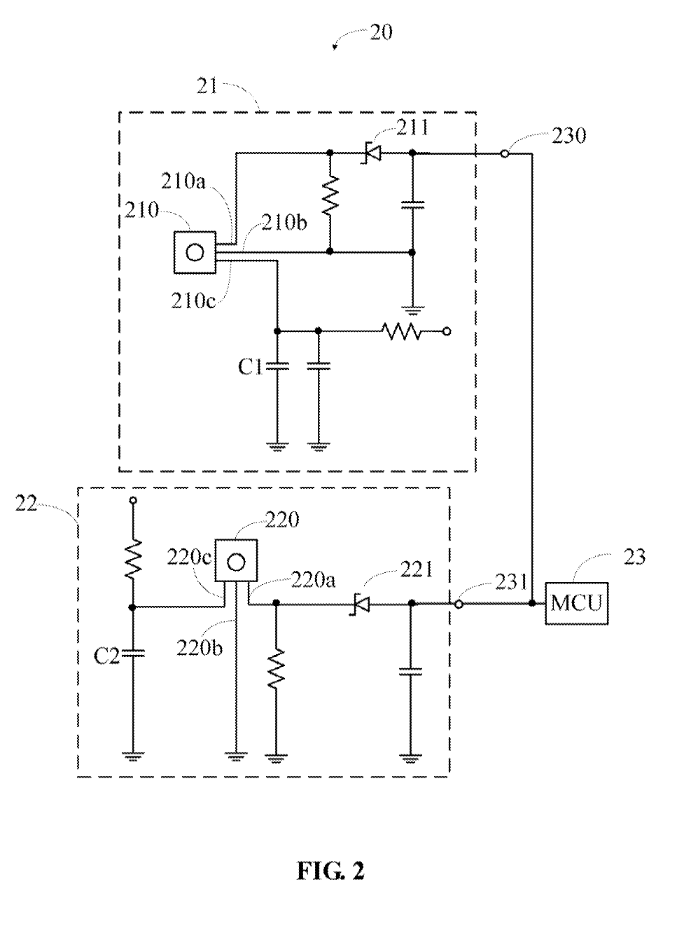

Referring to FIG. 2, an infrared remotely controlled circuit 20 employed in an electronic device having an infrared remote controller is disclosed. The infrared remotely controlled circuit 20 includes a first remotely controlled circuit 21, a second remotely controlled circuit 22, and a microprogrammed control unit (MCP) 23. The first infrared remotely controlled circuit 21 includes a first infrared receiver 210, and the second infrared remotely controlled circuit 22 includes a second infrared receiver 220. The first infrared receiver 210 and the second infrared receiver 220 are respectively mounted in a display panel (not shown) and a host machine (not shown) of the electronic device. In the embodiment, the first infrared receiver 210 and the second infrared receiver 220 are integrated circuits.

The first infrared receiver 210 includes a first port 210a, a second port 210b, and a third port 210c. The first remotely controlled circuit 21 further includes a first diode 211. The cathode of the first diode 211 is connected to the first port 210a, and the anode of the first diode 211 is connected to the MCU 23 to form a first signal input port 230. The second port 210b is grounded. The third port 210c is grounded via a capacitor C1.

The second infrared receiver 220 includes a first port 220a, a second port 220b, and a third port 220c. The second remotely controlled circuit 22 further includes a second diode 221. The cathode of the second diode 221 is connected to the first port 220a, and the anode of the second diode 221 is connected to the MCU 23 to form a second signal input port 231. The second port 220b is grounded. The third port 220c is grounded via a capacitor C2.

When the first infrared receiver 210 and the second infrared receiver 220 receive infrared signals transmitted by a remote controller, the first infrared receiver 210 outputs the infrared signals to the MCU 23 via the first signal input port 230, and the second infrared receiver 220 outputs the infrared signals to the MCU 23 via the second signal input port 231. The MCU 23 executes corresponding functions in response to the infrared signals.

When the first infrared receiver 210 and the second infrared receiver 220 transmit an infrared signal via the first diode 211 and the second diode 212 respectively, the second diode 221 prevents the infrared signal transmitted by the first infrared receiver 210 being further transmitted to the second signal input port 231, and the first diode 211 prevents the infrared signal transmitted by the second infrared receiver 220 being further transmitted to the first signal input port 230.

The present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An infrared remotely controlled circuit employed in an electronic device which comprises a display panel and a host machine, wherein the infrared remotely controlled circuit comprising:
a first remotely controlled circuit comprising:
a first infrared receiver for mounting in the display panel, configured for receiving an infrared remotely controlled signal transmitted by a remote controller;
a first diode, wherein the cathode of the first diode is connected to a first port of the first infrared receiver;
a second remotely controlled circuit comprising:
a second infrared receiver for mounting in the host machine, configured for receiving an infrared remotely controlled signal transmitted by a remote controller;
a second diode, wherein the cathode of the second diode is connected to a first port of the second infrared receiver; and
a microprogrammed control unit (MCU) connected to the anode of the first diode to form a first signal input port and the anode of the second diode to form a second signal input port.

2. The infrared remotely controlled circuit as claimed in claim 1, wherein the first infrared receiver and second infrared receiver are integrated circuits.

3. The infrared remotely controlled circuit as claimed in claim 1, wherein the first infrared receiver comprises a first port, a second port, and a third port, the first port is connected to the cathode of the first diode, the second port is grounded, and the third port is grounded via a capacitor.

4. The infrared remotely controlled circuit as claimed in claim 1, wherein the second infrared receiver comprises a first port, a second port, and a third port, the first port is connected to the cathode of the second diode, the second port is grounded, and the third port is grounded via a capacitor.
